(19) United States
(12) Patent Application Publication
(10) Pub. No.: US 2022/0061512 A1
(43) Pub. Date: Mar. 3, 2022

(54) Brush Easy

(71) Applicant: Ykesha Horton, Chicago, IL (US)

(72) Inventor: Ykesha Horton, Chicago, IL (US)

(21) Appl. No.: 17/009,861

(22) Filed: Sep. 2, 2020

(51) Int. Cl. A46B 5/00; A46B 11/00; A46B 17/00

(52) U.S. Cl. CPC A46B 5/0095; A46B 11/0003; A46B 2200/304; A46B 17/00; A46B 11/0065

(57) ABSTRACT

A toilet brush including, a crystal transparent container referring to (FIG. 1, A) this container will consist of transparent plastic giving a crystal glassy look but made from plastic. A crystal transparent handle referring to (FIG. 2, B) this handle will consist of a crystal shape giving a diamond cut look made from transparent plastic with a glassy realistic look. (FIG. 2, C) A flat surface made from plastic that sits on top of the container to hold toilet brush in place inside the container. A button referring to (FIG. 2, D,E) a brush stick following two buttons (FIG. 2, D,E) attached on sides of the brush stick to squeeze to eject the brush head soap. 3 is the attachment for the brush head and stick. Soap and air-freshener referring to (FIG. 4, J) This hard substance will consist of soap and air freshener, once the brush (FIG. 4, K) is inserted into the toilet bowl water it will automatically form soap (FIG. 4, J) with a good smell following. Once the brush is pulled from water it will no longer form soap this soap is only released by inserting water. Once the brush is out of water it will dry by natural room air more like an automatic dry. Brush head referring to (FIG. 5, M) The bristles will follow around the soap in a “U” shape following a circle shape around the top this is more of a housing for the soap to sit in the middle. The circle shape at the top of the brush will help to better clean underneath the rim of the toilet. (FIG. 5, L) This soap air freshener will sit in the middle of the “U’ shape bristles. (FIG. 6) is the ejectable brush head.

### BRIEF DESCRIPTION OF DRAWING

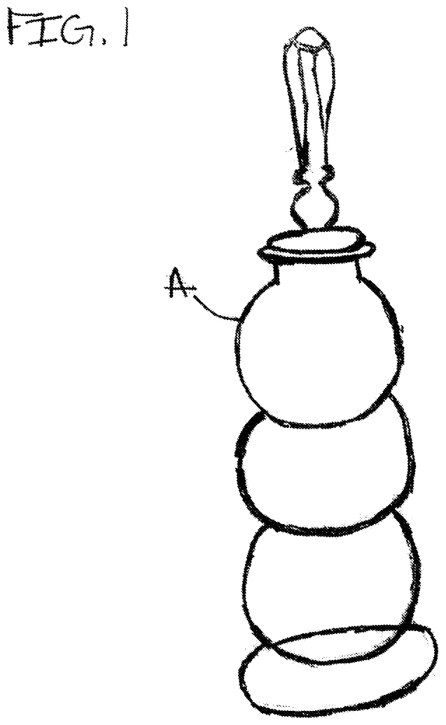

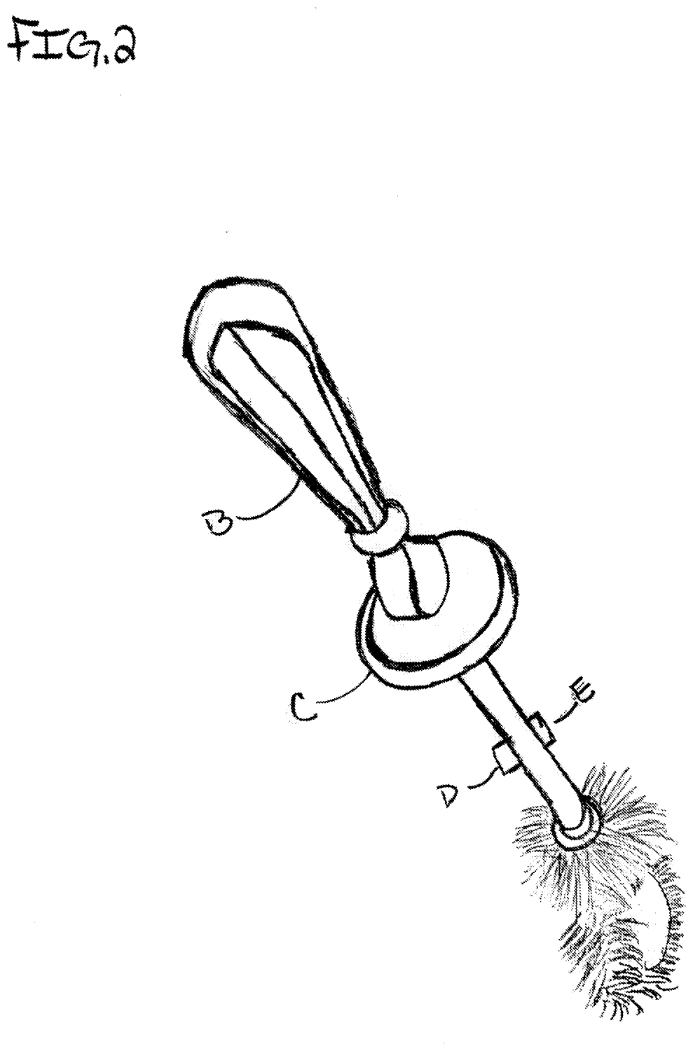

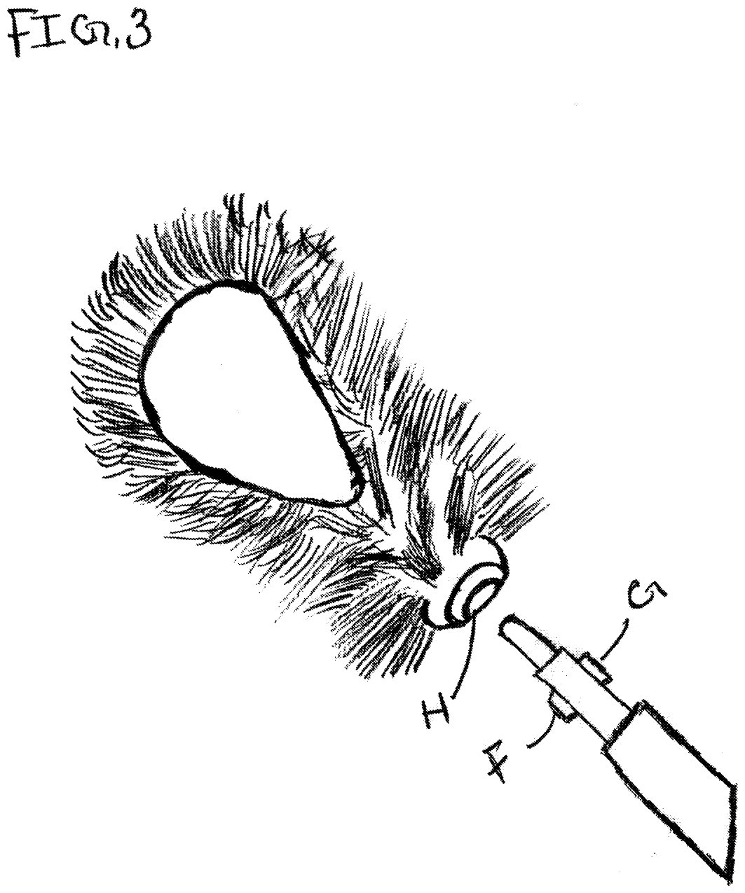

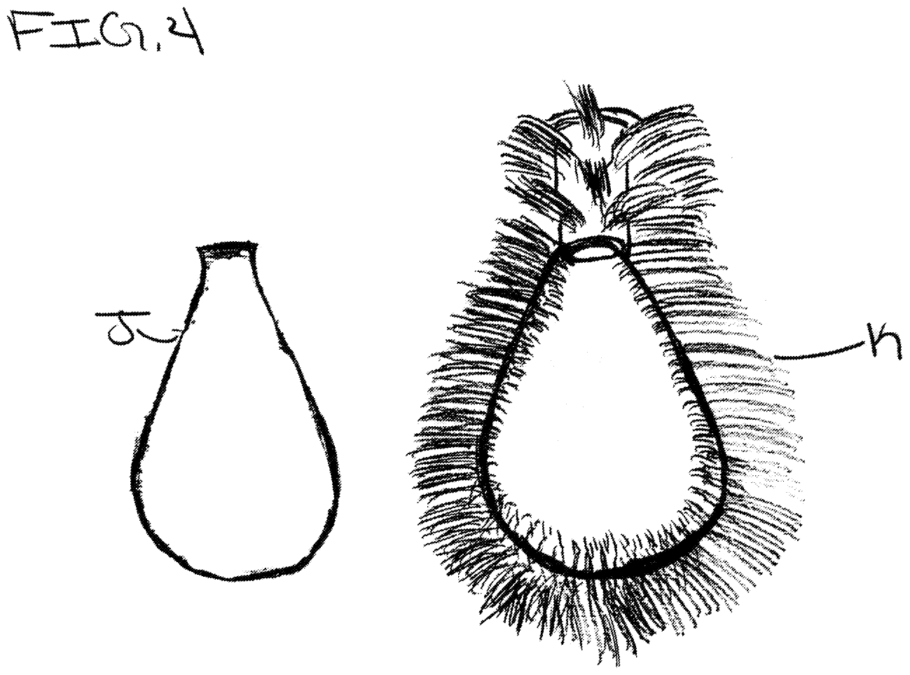

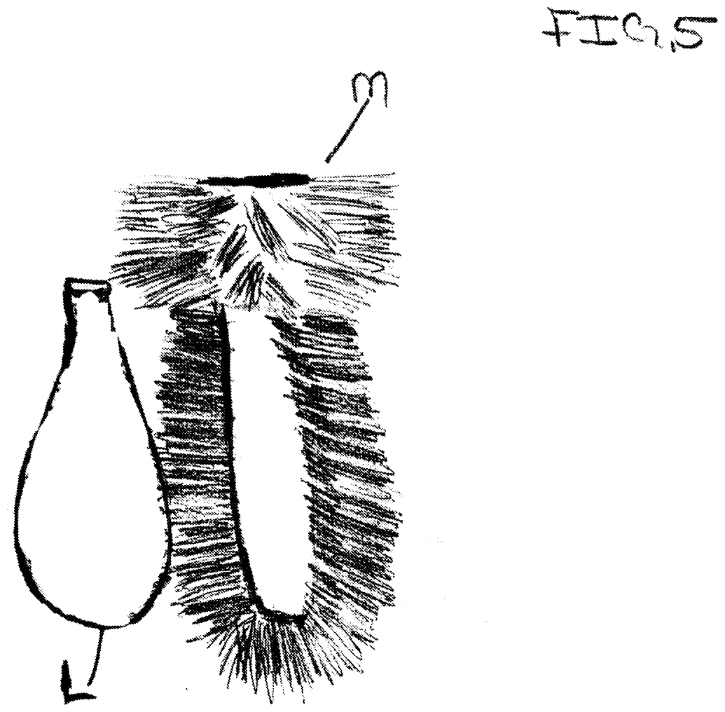

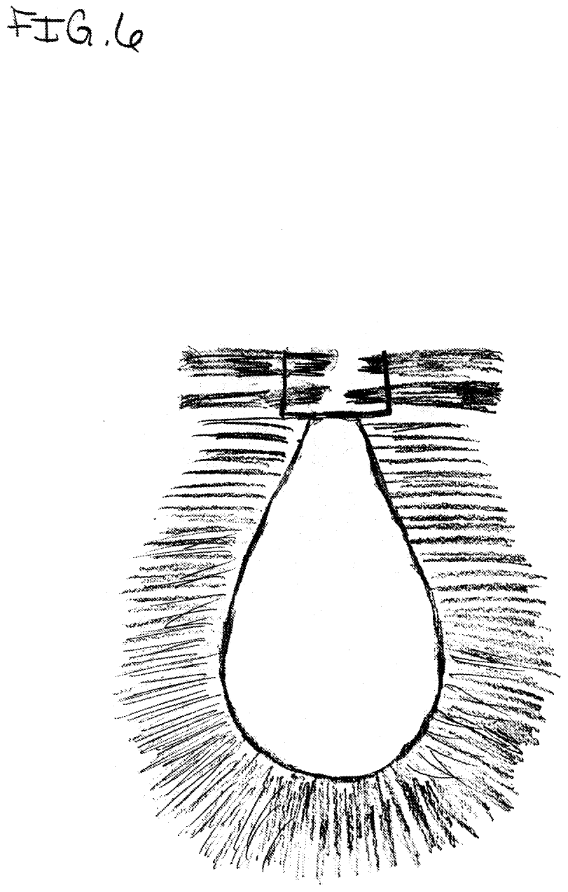

The concept of this new toilet brush (FIG. 1, A) is a front view of a new type of toilet brush that would feature transparent colors and build-in soap inside the brush head with an eject able head. This product would help to keep the toilet clean and sanitary. This toilet brush (FIG. 2, B) is a top view of a crystal transparent handle, this handle will consist of a crystal shape giving a diamond cut look made from transparent plastic with a glossy realistic look. (FIG. 2, C) is a top view of a round flat surface thick layer of plastic that would sit onto the container to hold the toilet brush in place, following two buttons (FIG. 2, D, E) these two buttons when pressed will eject the brush head when squeezed together. It would feature a removable brush head (FIG. 3, H) with soap (FIG. 4, J) and/or air freshener incorporated into its design. The soap/air freshener (FIG. 4, J) would be automatically released when the brush head is inserted into water. After using the brush for three to 6 months, the head could easily be released via the eject buttons (FIG. 2, D, E) and replaced as needed. The container (FIG. 1, A) would also be formed in a transparent plastic material. When the brush head is replaced after disposal it would connect back onto the brush stick. (FIG. 5, L, M) is also a side view of how the soap eject from brush head when needed to be replaced (FIG. 5, L) is soap (FIG. 5, M) is brush head both is designed to change when needed. (FIG. 6) is a front view of the brush head and soap connected.

### FUNCTIONS AND APPEALING FEATURES

This toilet brush would be timesaving's, light weight, compact size, convenience, efficiency, practicality novel and eye-catching design, and ease of operation. This handheld toilet bowl cleaner would ease the task of cleaning the toilet bowl. It would eliminate the stress of cleaning the toilet bowl using traditional methods.

The toilet brush would offer a more sanitary method of cleaning the toilet as the user would not have to touch the brush head. When needed, the head could be easily removed via an eject button and replaced as needed. This tool would clean the bowl more efficiently than traditional bowl brushes. It would also more effectively clean around the toilet bowl rim. The built-in soap and air freshener would offer a clean, refreshing scent and soap dispensing alternative.

This cleaning tool would provide easy cleaning of toilets, particularly for those with limited mobility. With this device, individuals could rest knowing that a toilet would be cleaned efficiently and quickly. It could contribute to a cleaner, more sanitary bathroom. This tool would be lightweight, easy to maneuver, efficient, timesaving, energy-saving and priced. As well as consumers at home, it would be appreciated by janitorial services and maintenance crews who maintain commercial and institutional facilities, including but not limited to schools, daycare centers, hospitals, etc.

I claim:

1. A toilet brush comprising:
A transparent container;
A crystal transparent handle;
A button;
A ejectable brush head;
soap/air freshener.

1. A toilet brush comprising:
A crystal transparent container referring to (FIG. 1, A) this container will consist of transparent plastic giving a crystal glassy look but made from plastic.

2. A crystal transparent handle referring to (FIG. 2, B) this handle will consist of a crystal shape giving a diamond cut look made from transparent plastic with a glassy realistic look. (FIG. 2, C) A flat surface made from plastic that sits on top of the container to hold toilet brush in place inside the container.

3. A button referring to (FIG. 2, D, E) a brush stick following two buttons (FIG. 2, D, E) attached on sides of the brush stick to squeeze to eject the brush head soap. 3 is the attachment for the brush head and stick

4. Soap and air-freshener referring to (FIG. 4, J) This hard substance will consist of soap and air freshener, once the brush (FIG. 4, K) is inserted into the toilet bowl water it will automatically form soap (FIG. 4, J) with a good smell following. Once the brush is pulled from water it will no longer form soap this soap is only released by inserting water. Once the brush is out of water it will dry by natural room air more like an automatic dry.

5. Brush head referring to (FIG. 5, M) The bristles will follow around the soap in a “U” shape following a circle shape around the top this is more of a housing for the soap to sit in the middle. The circle shape at the top of the brush will help to better clean underneath the rim of the toilet (FIG. 5, L) This soap air freshener will sit in the middle of the “U’ shape bristles. (FIG. 6) Is the ejectable brush head.
